(19) United States
(12) Patent Application Publication
(10) Pub. No.: US 2011/0270667 A1
(43) Pub. Date: Nov. 3, 2011

(54) Method and System for Customer Registration and Discount Distribution in an Affiliate Network

(75) Inventor: Jeff Kenny, Chicago, IL (US)

(73) Assignee: COUPONCABIN, INC., Chicago, IL (US)

(21) Appl. No.: 12/938,085

(22) Filed: Nov. 2, 2010

Related U.S. Application Data
(60) Provisional application No. 61/329,689, filed on Apr. 30, 2010.

(51) Int. Cl. G06Q 30/00

(52) U.S. Cl. 705/14.36

(57) ABSTRACT

An affiliate website may encourage a high level of customer participation and ensure that the affiliate and affiliate network receive a commission from sales using an online coupon without requiring a customer to register for and purchase the coupon. A customer may provide identifying information to an affiliate before the customer receives a coupon, and the affiliate may control the number of available coupons while ensuring commission credit for any resulting sale.

### CROSS-REFERENCE TO RELATED APPLICATIONS

This application claims the benefit of U.S. patent application Ser. No. 61/329,689 that was filed on Apr. 30, 2010 entitled “METHOD AND SYSTEM FOR CUSTOMER REGISTRATION AND DISCOUNT DISTRIBUTION IN AN AFFILIATE NETWORK.” U.S. patent application Ser. No. 61/329,689 is entirely incorporated by reference herein.

### TECHNICAL FIELD

The present disclosure generally relates to a system and method for providing an online discount code or “coupon” for online shoppers obtained from the provider's website, and, more particularly, for distributing exclusive coupons to online shoppers who register to receive the particular coupon.

### BACKGROUND

Online retailers have employed various methods to draw shoppers to their websites, including methods that have their origin in traditional, “brick and mortar” sales transactions. One method is the use of discounts in the form of coupons. Traditional coupons are offered to a potential customer through printed circulars, newspaper supplements, magazine advertisements, etc., and usually offer some sort of discount off of the regular sale price of an item. Bar codes or other identification marking on the printed coupons allow the retailer and manufacturer to track various information about the sale including the origin of the printed coupon (i.e., the newspaper, magazine, or other physical source of the coupon). By tracking information about the source of the coupon, the retailer or manufacturer may also provide a commission from the sale of the item o the coupon publisher as motivation to publish future coupons.

Coupons are also used in online sales transactions. Like printed coupons, sales commissions may be earned by entities that publish, aggregate, and maintain online coupon codes or discount URLs or “links” through affiliate marketing. One example of an online coupon system includes U.S. patent application Ser. No. 11/746,384 entitled “System and Method for Sharing Revenue Resulting from Online Coupon Use” filed on May 9, 2007, the entire disclosure of which is incorporated by reference herein. In an affiliate marketing relationship, a retailer or other online business rewards one or more third parties or “affiliates” for a sales transaction that originates from the affiliate's marketing efforts. Affiliate marketing typically includes four entities: a retailer, a network, a publisher or affiliate, and a customer. Affiliate networks partner with publishers that provide online coupon codes or discount links to help draw more customers to the retailers. In essence, a retailer will pay a sales commission to one or more of the network and the affiliate for directing potential customers to the retailer's website to complete a sales transaction. For example, online retailers may use the Google Affiliate Network, LinkShare, Commission Junction, or other networks to connect advertisers and publishers to increase sales and sales leads. This increased traffic leads to more sales using the retailer's website and is directly attributable to the effort of the network and the affiliate.

The network and affiliate are able to realize a sales commission if the retailer or other entity is able to directly credit a sale to the network and affiliate. The retailer, network, and affiliate are able to track the origin of the sale by using web browser cookies. Cookies are small pieces of text stored on a customer's computer by the customer's web browser. A cookie is made up of one or more name-value pairs containing bits of information. In an online sales transaction involving an affiliate network, the cookie may include information that identifies both the affiliate network and the affiliate to the retailer. A cookie becomes active or “set” by the requested web server when the customer initiates a web request. For example, a customer may select or “click” an online coupon code or discount link that is published on an affiliate's web site, which launches an affiliate referral process. The affiliate referral process activates a cookie sent from the affiliate network that identifies the affiliate on a web-enabled device. The affiliate network, in turn, sends a web request to the retailer's server and redirects the customer's browser to the retailer's site. The retailer server may then set another cookie on the customer's web-enabled device identifying both the affiliate and the affiliate network. When the customer accesses the retailer's site associated with the code, the retailer's web server may read the cookie with the retailer's domain on the customer's web enabled device in order to identify one or more of the affiliate and the affiliate network to the retailer.

Typically, a customer visits an affiliate's website (e.g., CouponCabin.com) by entering the affiliate's URL directly into the customer's browser, by a search engine, by following a link in an email, etc. The customer may find a discount link or coupon code for a retailer and then select or click that link or code that includes a request URL. Selecting the link or coupon sends the customer's browser to the affiliate network's server along with an identifying code contained in the request URL indicating that the affiliate was the referral source. The affiliate network's server/redirector sets a cookie on the customer's computer that identifies the affiliate and the affiliate network to the retailer. The customer's browser then redirects to the retailer's web site. The customer shops at the retailer's site, and as part of the checkout process, the customer may enter the coupon code in an appropriate field. Upon completion, the sale is logged to a server at the affiliate network and the affiliate network reports the completed transaction back to its source: the affiliate. The affiliate may earn a percentage commission on the sale according to terms agreed to with the retailer because the retailer was able to identify the affiliate from the information contained in the cookie.

Even if cookie use cannot be tracked, the retailer may still realize a net profit from coupon-related sales. For example, the coupon codes may be plainly visible short strings of text. Instead of clicking the discount link or coupon code to set the cookie on the customer's browser, a customer may simply memorize the code from the affiliate's site and manually type the code into the appropriate field on the checkout web page at the retailer's website. Typing in the code without clicking on the code on the affiliate's web site bypasses the entire affiliate referral process discussed above and prevents the affiliate and the affiliate network from earning a sales commission it would have otherwise received—yet the retailer still makes a sale and, minus the coupon discount, earns a profit from the sale.

The amount of profit a retailer makes from each sale is called the retailer's “profit margin.” While discounted sales reduce the profit margin for each item sold, the retailer's total profit may actually increase by occasionally offering discounted sales, due to the resulting increase in the number of sales. For example, more buyers may be persuaded to buy an item or service if it is offered at a discount. Depending on the type of discount offered by the coupon, the retailer may only realize a profit from the sales if the total number of discounted sales reaches a threshold number. For example, if a retailer offers a coupon for a 20% discount and only one or two customers (or a very low number of customers) takes advantage of the offer, that few number of sales will not realize enough profit to make up for the cost of promoting the coupon given the decreased profit margin of such discounted sales. Only if a minimum threshold number of customers take advantage of the coupon will the retailer be able to realize a profit from the discounted sales.

Because a retailer cannot accurately predict how many customers will take advantage of a coupon once it is published, the retailer may be reluctant to offer discounts or may only offer a discount if a threshold number of customers commit to take advantage of the discount. For example, some systems offer daily discounts for customers to purchase. If a minimum threshold number of customers commit to purchase the coupon, then the system may “activate” the coupon and complete the sale with the customers who committed to buying the coupon. For example, a customer may commit to purchase a $40 coupon worth $80 off the final bill at a local restaurant if a threshold minimum number of other customers commit to purchase of the coupon. In another example, a customer may commit to the purchase of a coupon for a product at a savings from the retail price (e.g., twelve pizzas for $65) if a threshold number of customers also commit to the coupon purchase. Thus, by committing to purchase some portion of the total savings, the customer not only makes a financial commitment in order to take advantage of the discount but also passes some financial gain to the entities within the affiliate network, whether or not the customer ultimately uses the purchased coupon.

However, these other discount purchase systems also include barriers to the customer. For example, past systems required a customer to register with the web site as well as complete a sales transaction before the coupon becomes active and enables the customer to realize any savings. Further, requiring a minimum threshold number of customers to commit to the purchase of the coupon before it becomes active means that customers will not know whether their commitment will result in a discount until after the threshold is met or the time period for the offer expires. Thus, while past systems may have ensured retailers a minimum number of customers' commitments to purchase a coupon, these past systems included barriers that at least discouraged immediate participation in the offer.

### SUMMARY

An affiliate website may encourage a high level of customer participation and ensure that the affiliate and affiliate network receive a commission from sales using an online coupon without requiring a customer to register for and purchase the coupon. A customer may provide identifying information to an affiliate before the customer receives a coupon, and the affiliate may control the number of available coupons while ensuring commission credit for any resulting sale.

### BRIEF DESCRIPTION OF THE DRAWINGS

FIG. 1 illustrates an exemplary block diagram of a computer network and system on which an exemplary customer registration and coupon distribution system and method may operate in accordance with the described embodiments;

FIGS. 2A, 2B, and 2C illustrate exemplary objects that may be used within a computer network and system on which an exemplary customer registration and coupon distribution system and method may operate in accordance with the described embodiments;

FIG. 3 illustrates an exemplary block diagram of a flow chart for one embodiment of a method for registering customers and distributing coupons;

FIG. 4A illustrates an exemplary screen shot of a web page that facilitates a method for registering customers and distributing online coupons;

FIG. 4B illustrates another exemplary screen shot of a web page that facilitates a method for registering customers and distributing online coupons;

FIG. 4C illustrates an exemplary screen shot of an email message that facilitates a method for registering customers and distributing online coupons;

FIG. 4D illustrates an exemplary screen shot of a webpage including a confirmation message to facilitate a method for registering customers and distributing online coupons;

FIG. 4E illustrates an exemplary screen shot of an email message including an online coupon;

FIG. 5 illustrates an exemplary block diagram of a flow chart for one embodiment of a method for registering customers and distributing coupons;

FIG. 6 illustrates an exemplary block diagram of a flow chart for the completion of an affiliate referral process;

FIG. 7A illustrates an exemplary screen shot of a retailer's webpage; and

FIG. 7B illustrates an exemplary screen shot of a further webpage from an online retailer after a customer enters a discount code and realizes a savings corresponding to the discount code.

### DETAILED DESCRIPTION

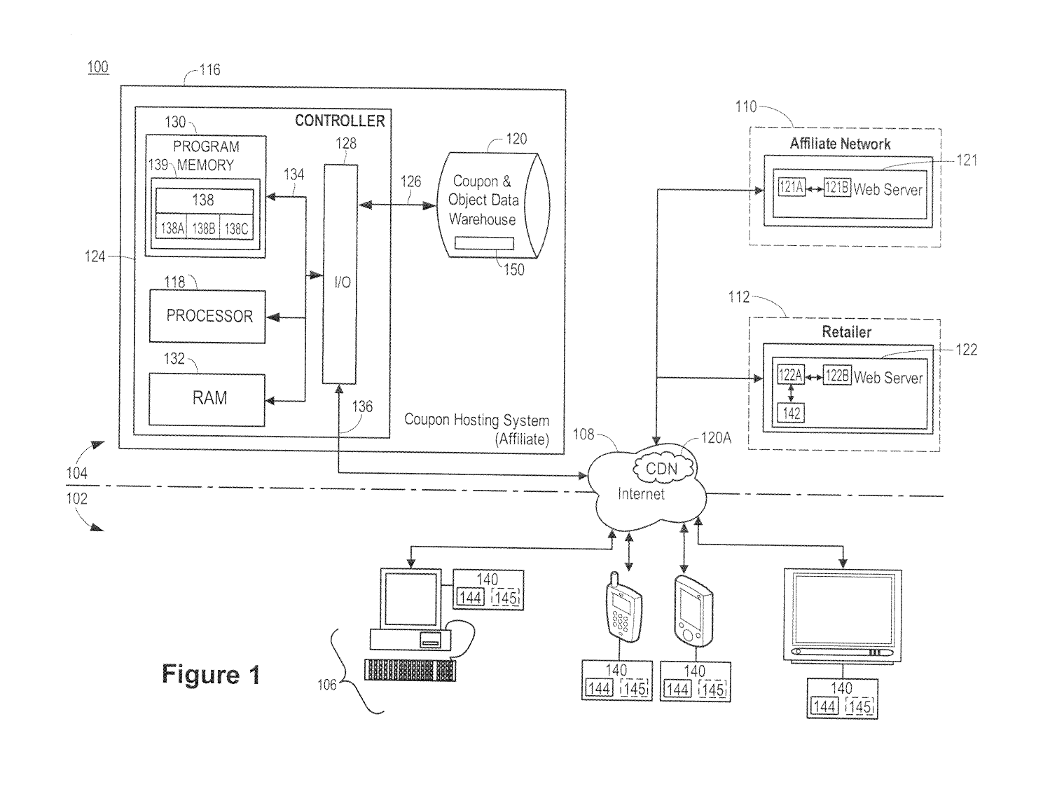

FIG. 1 illustrates various aspects of an exemplary architecture implementing an online system and method for registering customers and distributing coupons 100. In particular, FIG. 1 illustrates a block diagram of the exemplary online customer registration and coupon distribution system 100. The high-level architecture includes both hardware and software applications, as well as various data communications channels for communicating data between the various hardware and software components. The online customer registration and coupon distribution system 100 may be roughly divided into front-end components 102 and back-end components 104. The front-end components 102 are primarily web-enabled devices 106 (personal computers, smart phones, PDAs, televisions, etc.) connected to the internet 108 by one or more customers. The web-enabled devices 106 may be located, by way of example rather than limitation, in separate geographic locations from each other, including different areas of the same city, different cities, or even different states.

The front-end components 102 communicate with the back-end components 104 via the Internet or other digital network 108. In some embodiments, the web-enabled devices 106 may communicate with the back-end components via the Internet 108. The digital network 108 may be a proprietary network, a secure public Internet, a LAN, a virtual private network or some other type of network, such as dedicated access lines, plain ordinary telephone lines, satellite links, combinations of these, etc. Where the digital network 108 comprises the Internet, data communication may take place over the digital network 108 via an Internet communication protocol. The back-end components 104 include a coupon hosting system 116 or “affiliate” such as CouponCabin.com or other internet-based, publicly-accessible system, an affiliate network 110, and a retailer 112. Additionally or alternatively, the coupon hosting system 116 may be web server in communication with a private or secure LAN. The coupon hosting system 116 may include one or more computer processors 118 adapted and configured to execute various software applications, modules, functions, routines, and components of the online customer registration and coupon distribution system 100. These various applications, etc., may, in addition to other software applications, allow an affiliate to receive credit for referring customers to a retailer's website, as further described below. The coupon hosting system or web server 116 further includes a data warehouse or database 120. The data warehouse 120 is adapted to store coupon codes, discount uniform resource locators (URLs), and other content to be hosted by the coupon hosting system 116 and displayed on a website. The data warehouse 120 may also be configured to store customer identifying information within a data structure 150 for use in registering customers and distributing coupons, as herein described. Some examples of data structures include a linked data structure, an abstract data structure, a concurrent data structure, an array, a list, a queue, a tree, a hash table, a graph, and a database, to name only a few. The coupon hosting system 116 may access data stored in the data warehouse 120 when executing various functions and tasks associated with the operation of the online customer registration and coupon distribution system 100, as described herein.

Although the online customer registration and coupon distribution system 100 is shown to include a coupon hosting system 116 in communication with three web enabled devices 106, an affiliate network 110 and a retailer 112, it should be understood that different numbers of processing systems, computers, customers, affiliate networks, and retailers may be utilized. For example, the Internet 108 may interconnect the system 100 to a plurality of coupon hosting systems, other affiliate networks 110, retailers 112, and a vast number of web-enabled devices 106. According to the disclosed example, this configuration may provide several advantages, such as, for example, enabling near real-time updates of coupon codes from the retailers 112, changes to the discount links or coupons from the retailers 112, as well as periodic uploads and downloads of information. Both the affiliate network 110 and retailer 112 may include one or more web servers 121, 122, respectively. The affiliate network web server 121 may include information, applications, modules, routines, instructions, etc., to register one or more customers to receive an online coupon and identify the coupon hosting system 116 (i.e., the affiliate) to the retailer 112 in addition to facilitating communication between the web-enabled devices 106, coupon hosting system 116, and retailer 112. The retailer web server may include information, applications, modules, routines, instructions, etc., to facilitate an online purchase transaction including a coupon code, as further explained herein. Each web server 121, 122 may be a computing apparatus that includes a memory 121A, 122A to store the information, applications, etc., and a processor or controller 121B, 122B to execute the various applications, routines, modules, instructions, etc., as also described herein.

FIG. 1 also depicts one possible embodiment of the coupon hosting system 116. The coupon hosting system 116 may have a controller 124 operatively connected to the data warehouse 120 via a link 126 connected to an input/output (I/O) circuit 128. It should be noted that, while not shown, additional databases or data warehouses may be linked to the controller 124 in a known manner.

The controller 124 includes a program memory 130, the processor 118 (may be called a microcontroller or a microprocessor), a random-access memory (RAM) 132, and the input/output (I/O) circuit 128, all of which are interconnected via an address/data bus 134. It should be appreciated that although only one microprocessor 118 is shown, the controller 124 may include multiple microprocessors 118. Similarly, the memory of the controller 124 may include multiple RAMs 132 and multiple program memories 130. Although the I/O circuit 128 is shown as a single block, it should be appreciated that the I/O circuit 128 may include a number of different types of I/O circuits. The RAM(s) 132 and the program memories 130 may be implemented as semiconductor memories, magnetically readable memories, and/or optically readable memories, for example. A link 136 may operatively connect the controller 124 to the Internet 108 through the I/O circuit 128.

The coupon hosting system 116 may have various different structures and methods of operation. It should also be understood that while the embodiment shown in FIG. 1 illustrates some of the components and data connections that may be present in a coupon hosting system 116, it does not illustrate all of the data connections that may be present. For exemplary purposes, one design of a coupon hosting system is described herein, but it should be understood that numerous other designs may be utilized.

The program memory 130 may contain coupon hosting system (affiliate) data and objects 138A, 138B, 138C that may be displayed within a coupon hosting website 139 on a web-enabled computing device 106. The data and objects 138A, 138B, and 138C may be stored in a variety of structures or areas within the front end 102 or back end 104 of the system 100. For example, the data and objects 138A, 138B, and 138C may be stored within the coupon and object data warehouse 120, the content delivery network 120A, a remote data storage facility, etc.

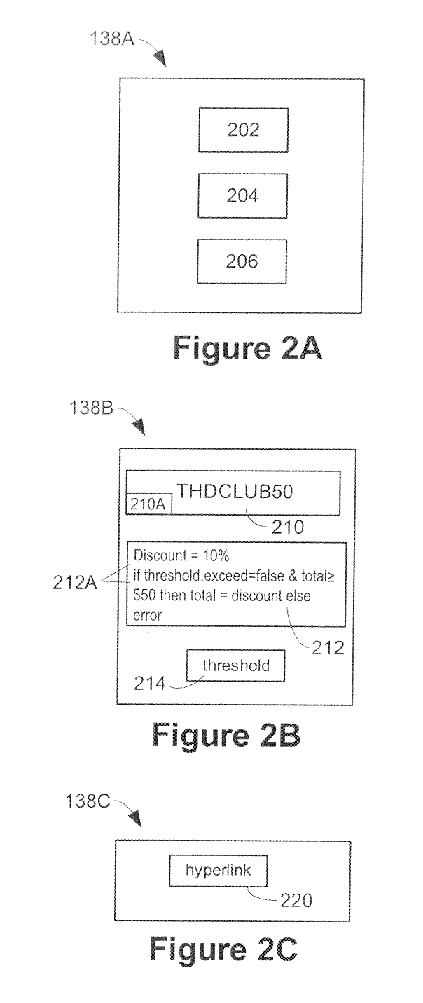

With reference to FIGS. 2A, 2B, and 2C, various examples of data and objects 138 may be used by the system 100. The objects 138 may include client-side computer code such as JavaScript, (i.e., “scripts”) code implementing Ajax techniques, or other types of code for facilitating the methods described herein. As illustrated by FIG. 2A, one example of a coupon hosting system object 138 includes a clickable object 138A that may be used to call various functions related to registering a customer's identifying information, distributing a coupon, tracking a sale that uses the coupon, or any other functions and methods as described herein. A clickable object 138A may be any type of static or dynamic object that may include a function 202 or may include a function to call a remote function 204 to be executed by the processor 118 or cause an action to occur when a customer selects the object with a pointer or “clicks” on the object. In some embodiments, the clickable object 138A is a JavaScript browser object (e.g., a button object, an area object, a text object, etc.) with configurable properties 206 that determine how the clickable object 138A is displayed and what function 202, 204 may be called when the customer clicks on it.

Another coupon hosting system object 138 may include a coupon object 138B. With reference to FIG. 2B, a coupon object 138B may include a discount code 210 and a discount 212. The discount code 210 may include any combination of letters, numbers, or other symbols that may correspond to a discount 212 or savings off of a retailer's regular price for goods or services. The discount code 210 may also include a reference 210A or other association to a retailer that indicates a source of the discount. The discount 212 may include one or more conditions 212A that, if met, result in a reduction in a retailer's normal price for a good or service. While the conditions 212A reflected in FIG. 2B indicate a discount of 10% if a customer's total order from a retailer is equal to or greater than $50, various other conditions for the discount 212 are possible including placing an order with any total amount, placing an order for a specific item or category of item, etc. The discount 212 and conditions 212A may also refer to a threshold 214. The threshold 214 may include an indication of a limitation on the effectiveness of the discount 212. For example, the threshold 214 may include a expiration date, customer limit, period of effectiveness, or any other limitation that restricts how or when the discount 212 may be applied to a customer's order from a retailer.

With reference to FIG. 2C, another coupon hosting system object 138 may include a link object 138C. The link object 138C may include data and functions to ensure one or more of the affiliate 116 and affiliate network 112 receive commission credit for a customer's purchase of goods or services from the retailer 112. For example, the link object 138C may include a hypertext link 220 to redirect a user's web browser client 140 to a web page of a retailer's website 142 and facilitate the cookie setting and tracking processes as herein described.

While the data and objects 138 of the coupon hosting system (affiliate) website 139 are depicted in FIGS. 1, 2A, 2B, and 2C as including three objects 138A, 138B, and 138C, the data and objects may include any number of objects to produce a coupon hosting system website 139 as described herein. Further, while FIG. 1 depicts the objects 138 and website 139 as being stored in a program memory 130, the objects 138 and website 139 may be stored apart from the program memory 130, the system 116, or as part of a content delivery network 120A located at various points in the network 108.

By way of example and not limitation, the coupon hosting system data and objects 138, or the objects 138A, 138B, and 138C may also include one or more applications, modules, routines, instructions, data, etc., to do one or more of the following: register a customer's e-mail address with the system 100; associate a customer's registered e-mail address with a coupon; wait a threshold amount of time to register additional customer e-mail addresses; limit the number of customers that register for the coupon; generate an e-mail message to each registered customer, the e-mail message including one or more of a coupon code and a discount link; limit an amount of time the coupon code and/or discount link is active for the registered customer to realize a discount; distribute the e-mail message including the coupon code and/or discount link to each registered customer using the registered customer's e-mail address or other identifying information; upon a customer's selection of the discount link, call a function to cause a web browser cookie 144, 145 from one or more of the affiliate network 110 or the retailer 112, respectively, to be set on a customer's web-enabled device 106; identify the origin of a coupon code and/or discount link to a retailer 112, affiliate network 110, or other entity; call a function to launch a retailer's website upon the customer selecting a clickable object; etc. Using the data and objects 138, the coupon hosting system 116 may execute one or more of the various parts of the methods described herein with reference to the remaining Figures.

Returning to FIG. 1, the web servers 110, 112 may each include a controller similar to the controller 124 described above with similar functionality and including data and objects to host a website (e.g., retailer's website 142, coupon hosting website 139, etc.). All servers may further include a display and a keyboard as well as a variety of other input/output devices (not shown) such as a scanner, printer, mouse, touch screen, track pad, track ball, isopoint, voice recognition system, digital camera, etc.

Various software applications and functions resident in the front-end components 102 and the back-end components 104 implement the customer registration and coupon code distribution methods, implement functions called by the clickable objects 138A, and provide various customer interface methods to allow customers and other parties to an online sales transaction to access and use the system 100. One or more of the front-end components 102 and/or the back-end components 104 (e.g., the coupon hosting system 116) may include various video, image, and graphic design applications to permit the implementation of a coupon hosting website 139.

Each web-enabled device 106 may also include a customer interface application that may be a web browser client 140 for accessing the coupon hosting system (affiliate) 116, affiliate network 110, and retailer 112 generally and the coupon hosting website 139, affiliate web server 121, and retailer website 142 in particular. In some embodiments, the web browser client 140 is an Internet Explorer® web browser (produced by Microsoft Corporation of Redmond, Wash.) or the Firefox® web browser (produced by the Mozilla Foundation of Mountain View, Calif.) to name only a few possible web browsers. The browser(s) 140 may be any type of web browsing client, including a proprietary client, and may communicate with the various servers 121, 122 and the coupon hosting system 116 using any type of protocol including, but not limited to, file transfer protocol (FTP), telnet, hypertext-transfer protocol (HTTP), etc.

Each browser may also include or have access to one or more cookies 144, 145 to be set before an affiliate receives credit for directing a customer to a retailer's website to conduct a sales transaction. The information sent to and from the servers 121, 122 and/or the coupon hosting system 116 may include data retrieved from the data warehouse 120, content delivery network (CDN)120A, and/or program memories 121A, 121B. The coupon hosting system 116 and/or the servers 121, 122 may implement any known protocol compatible with the website 139 accessed by the web-enabled devices 106 and adapted to the purpose of registering customers and distributing discounts in an affiliate network.

The coupon and object data warehouse 120, the CDN 120A, and program memories 121A, 121B, may include graphics, text, and other objects 138A, 138B, 138C for display within a coupon hosting system website 139, as described herein. For example, graphics may be provided by the system 100 for use within any portion of a website, URLs or other links 138C to retailer websites 142, JavaScript browser objects (e.g., buttons, etc.) or other interactive objects that, when activated by a customer, may display other resources such as online coupon codes, or may perform any of the methods and functions described herein. As generally known in the art, the buttons and clickable objects may include text (some of which may be displayed as hyperlinks or “links” and URLs to additional information and other websites), data entry boxes or text fields, pull-down lists, radio buttons, check boxes, and images. Throughout this specification, it is assumed that the buttons and clickable objects 138A refer to graphic and text elements or representations for display within a webpage that are associated with functions executed by a processor. The functions of the clickable objects may be called, activated, or instantiated by a customer using a mouse or other pointing device. Thus, throughout the specification, the terms “click” and “clicking” may be used interchangeably with the terms “select,” “activate,” or “submit” to indicate the selection or activation of one of the functions associated with the display elements. Of course, other methods (e.g., keystrokes, voice commands, etc.) may also be used to select or activate the functions associated with the various buttons. Moreover, throughout this specification, the terms “link” and “button” are used interchangeably to refer to a graphic representation of a command that may call a method, function, or function block (i.e., the various “block #” as described below) including one or more instructions that are executed by a processor or controller by clicking on the graphic representation or hyperlink.

The methods for registering customers and distributing online discounts may include one or more functions that may be stored as computer-readable instructions on a computer-readable storage medium, such as a program memory 130, or optical, magnetic, or flash memory, and may include the objects 138B, 138C and clickable objects 138A as described herein. The instructions are generally described below as “blocks” or “function blocks” proceeding as illustrated in the flowcharts described herein. While the blocks of the flowcharts are numerically ordered and described below as proceeding or executing in order, the blocks may be executed in any order that would result in customer registration for an online coupon and distribution of that coupon to the registered customer, as described herein.

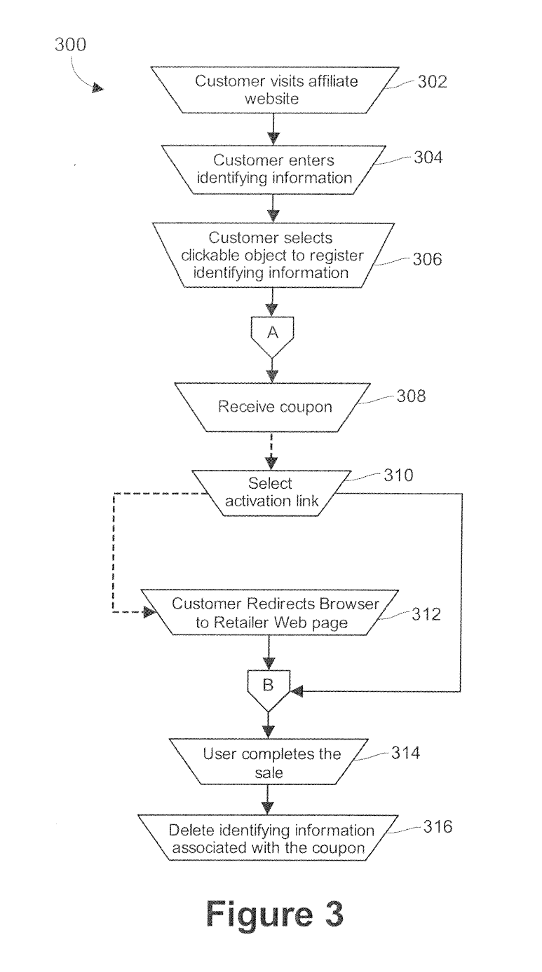

FIG. 3 illustrates one embodiment of a method 300 for registering customers and distributing online coupons. At block 302, a customer may access the Internet 108 to visit an affiliate website 139 to retrieve online purchase discount codes by requesting access to the website using a browser. The website 139 may include a plurality of web pages each made up of a plurality of objects (e.g., the objects 138A, 138B, 138C from FIG. 1) formatted using a hypertext language such as HTML, XHTML, etc., and may provide navigation to other web pages via hypertext links.

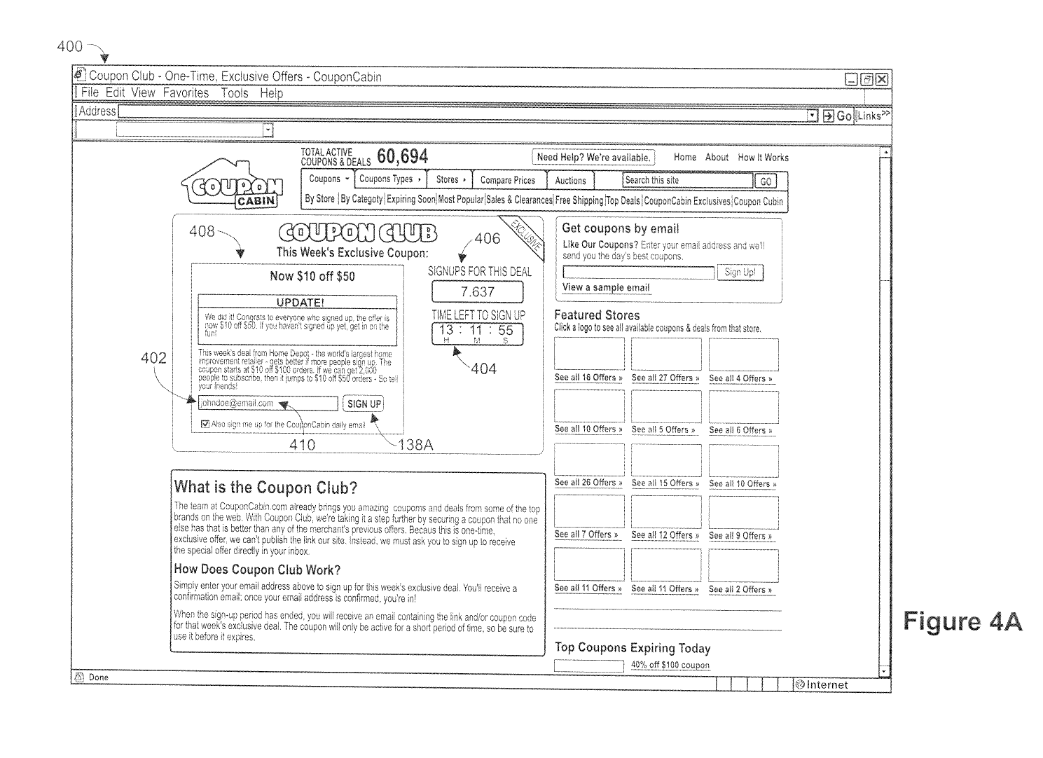

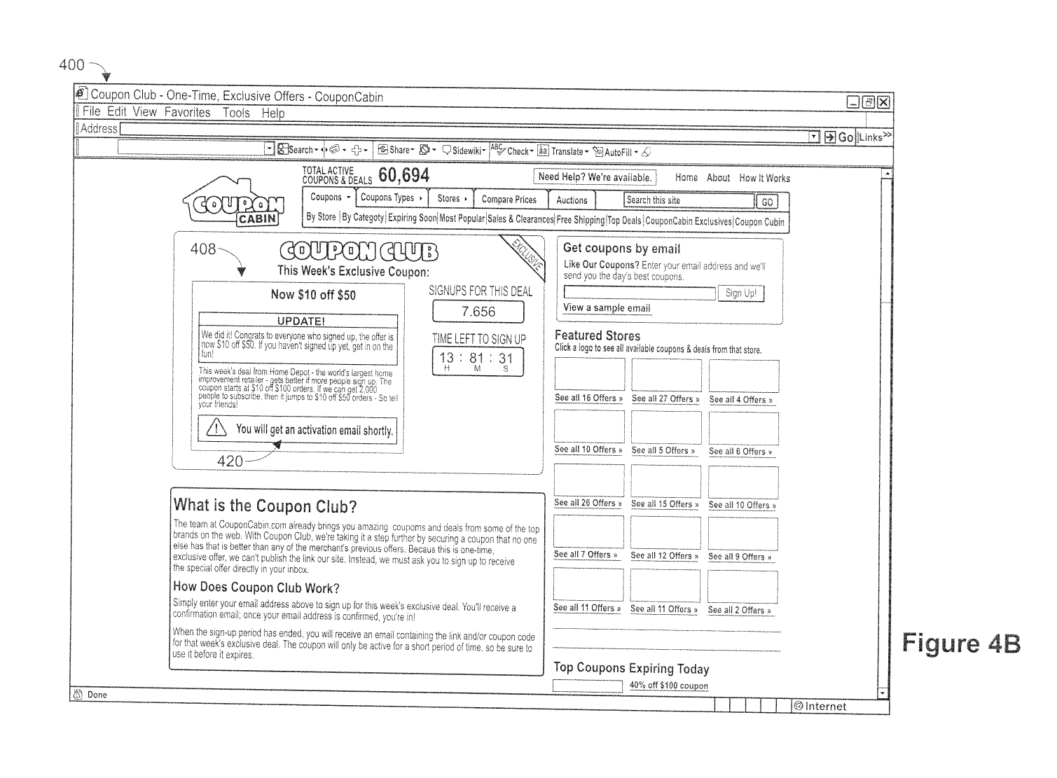

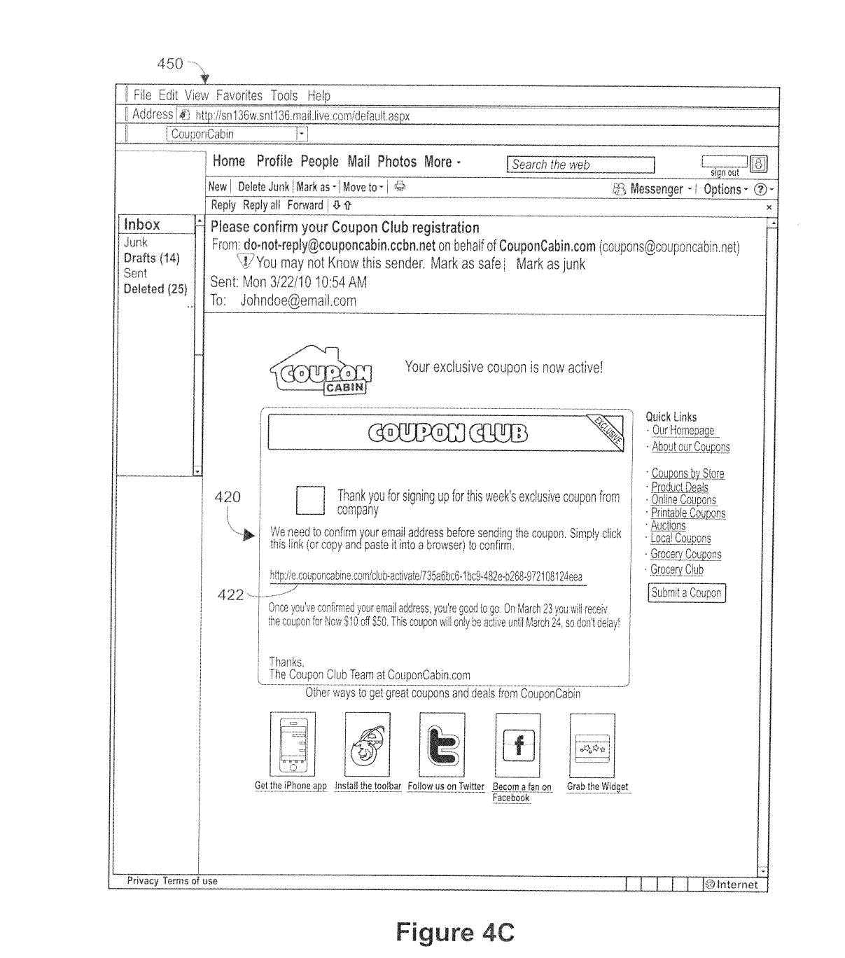

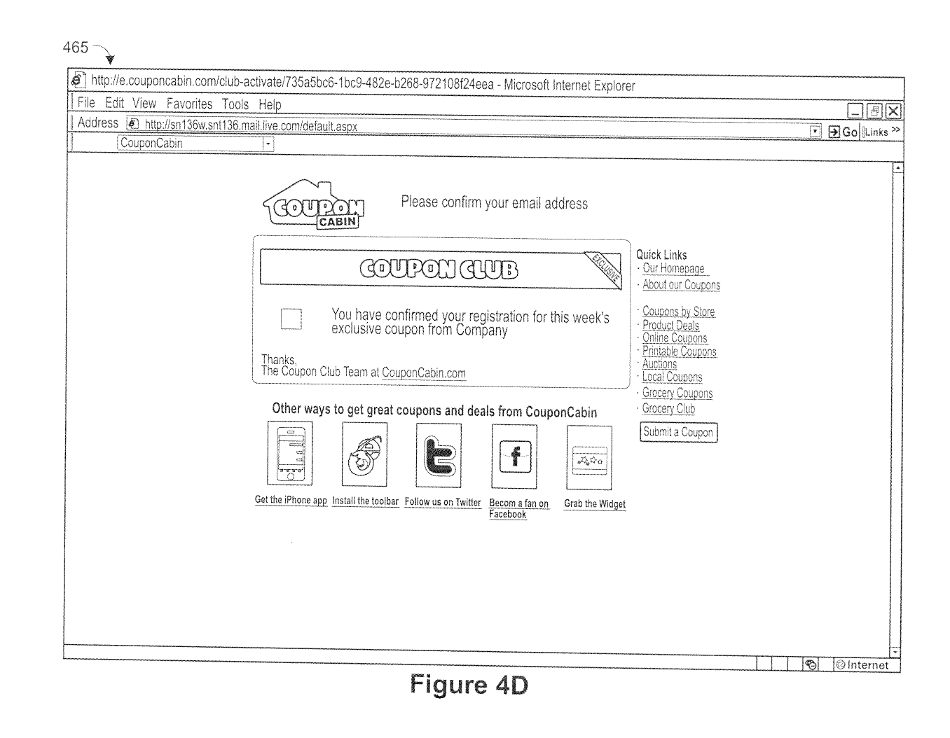

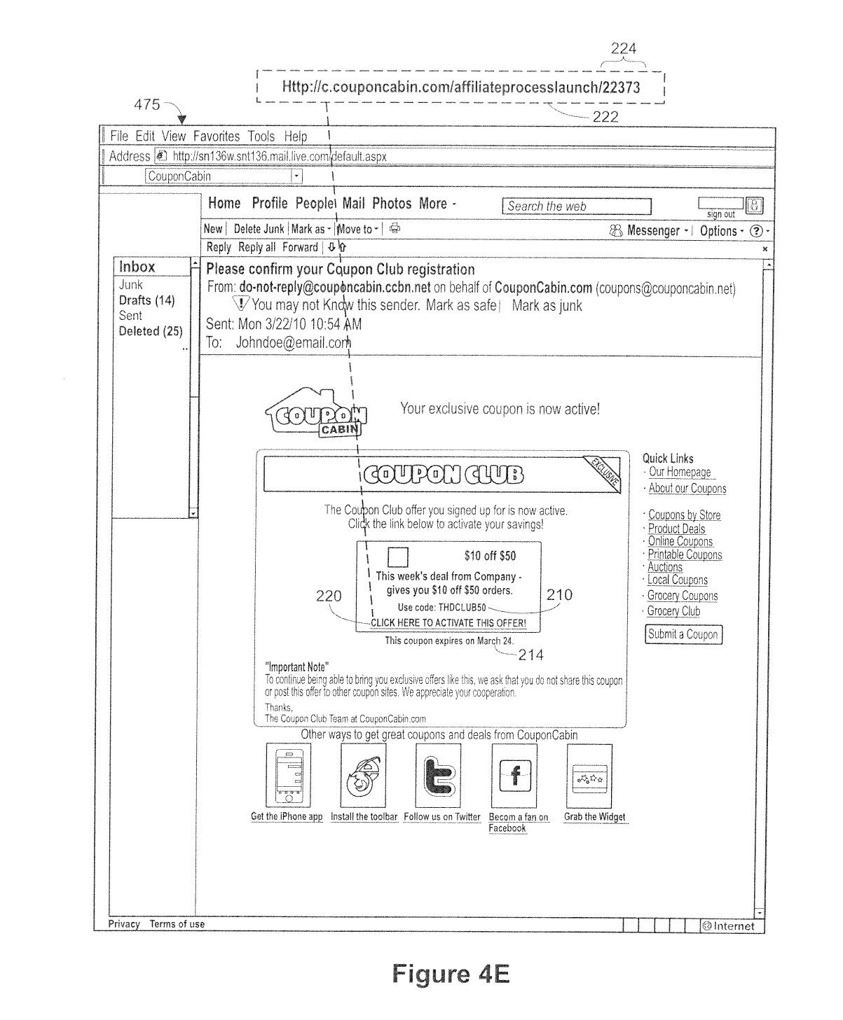

FIG. 4A is an embodiment of a web page 400 from an affiliate or coupon hosting system website 139 that may be stored as a plurality of objects (e.g., 138A, 138B, 138C as described above in relation to FIGS. 2A, 2B, and 2C) within the coupon hosting system 116, the program memory 130, data warehouse 120, content delivery networks 120A, etc. The web page 400 may be retrieved from memory at a local computer (e.g., the data warehouse 120, the program memory 130, etc.) or from a remote web server (e.g., the content delivery network 120A). Web page 400 may be requested and served from a web server (e.g., the coupon hosting system 116) using Hypertext Transfer Protocol (HTTP).

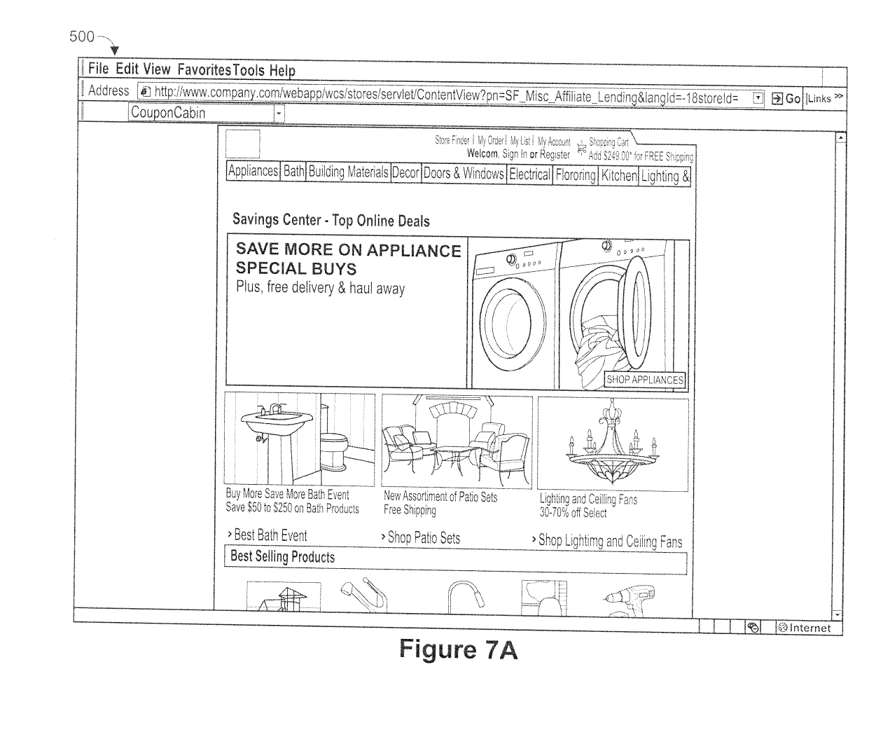

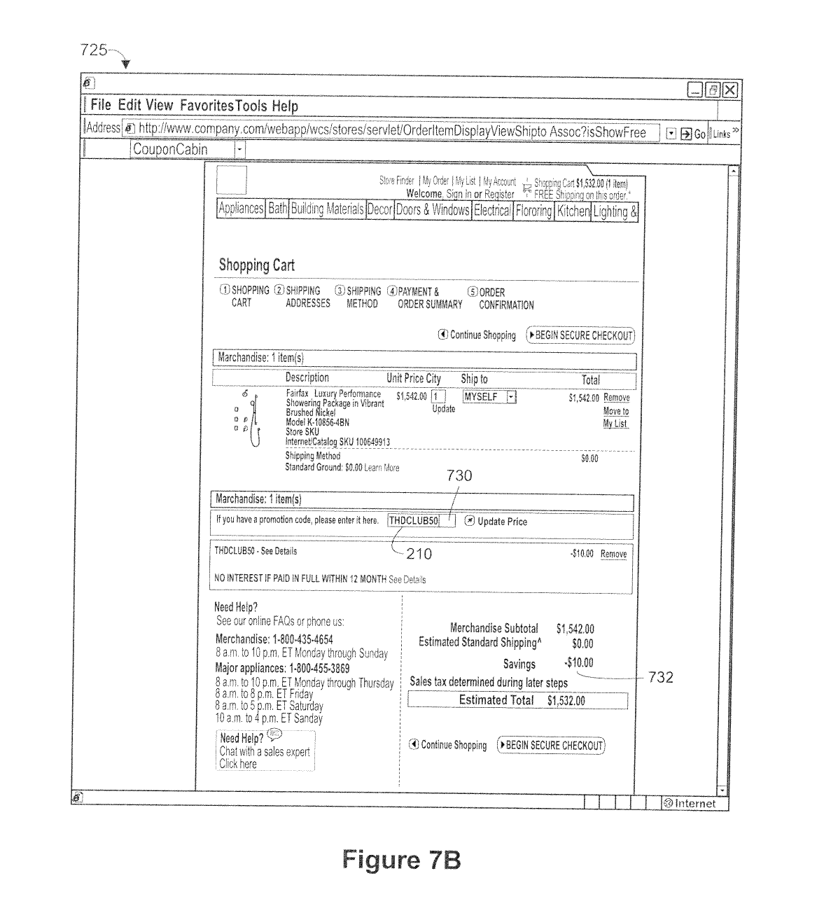

The web page 400 may include files of static text stored as one or more objects 138A, 138B, 138C within the coupon hosting system 116, or the system 116 may construct the (X)HTML for each web page when it is requested by the customer's browser (i.e., dynamic web pages). The objects 138A, 138B, 138C or scripts may be provided by the coupon hosting system 116 as embedded in the HTML of the web page 300 or as separate, linked objects that may be downloaded from other sources as specified in the web page 400 HTML. Further, these objects or scripts may run within the customer's browser on the client computer, if the customer allows. The above description of the affiliate website 139 and web pages applies equally to the retailer website 142 (and web page 700 of FIG. 7A), and objects stored within or accessed by the affiliate network web server 121.

In some embodiments, the objects 138A, 138B, 138C within the web page 400 may include a text box 402, a clickable object 138A, a countdown object 404, a total customers object 406, an information section 408, etc. The text box 402 may accept a customer's identifying information 410 or other information (e.g., an e-mail address, mobile phone number, etc.) that may be used to send or receive digital data (e.g., a coupon, discount code, etc.). The clickable object 138A may include text or other data that identifies a function that may be executed upon clicking the object 138A. As described above in relation to FIG. 2A, the clickable object 138A may also include several functions to convey other information to a customer viewing the webpage 400. For example, upon a “mouse over” or other customer-initiated event (click, roll over, etc.), the clickable object 138A may display additional text or other information to direct the customer to further select or click the clickable object 138A.

At block 304, a customer may enter identifying information 410 into the text box 402. In some embodiments, the identifying information 410 is an email address. In other embodiments, the identifying information is a mobile phone number, mailing address, or other information that may be used to send digital data, physical mail, or other information representing a coupon as herein described.

At block 306, a customer may click or select the clickable object 138A. Generally described, selecting the clickable object 138A may call a function or other instructions to be executed by the processor 118 to register the customer using the identifying information 410. Of course, the customer may perform any action to call a function or other instructions to be executed by the processor as described herein (e.g., highlighting the clickable object 138A and pressing an enter or return button, using a stylus and touch-sensitive monitor, track ball, eye-tracking device, etc.).

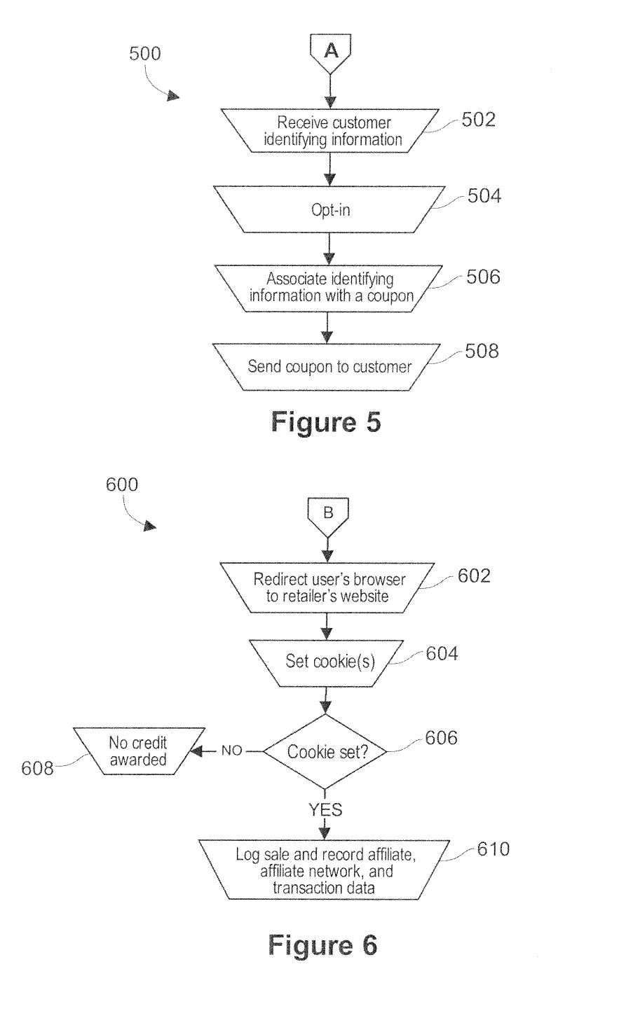

Completion of the functions and methods associated with block 306 may cause a processor 118 to execute another method to complete registration of the customer. For example, FIG. 5 illustrates one embodiment of a method 500 for registering a customer to receive a coupon or other online discount. At block 502, the system 100 may receive the identifying information 410 described above in relation to the method 300. In some embodiments, the system 100 may receive the identifying information 410 at a component of the back end 104 as sent from a component at the front end 102. For example, a customer may access a web page 400 at the affiliate website 139 using a browser 140 of a customer's web-enabled device 106. After entering identifying information 410 into a text box 402 and selecting the clickable object 138A, the function called by the clickable object 138A may include a remote or local procedure call to send the identifying information 410 from the web browser 140 to the coupon hosting system 116 through the network 108 via the data link 136.

At block 504, the method 500 may display and send registration information 420 (FIG. 4B) and 430 (FIG. 4C) to complete a process to ensure that the identifying information 410 entered at block 304 (FIG. 3) is actually associated with the customer who entered the information (i.e., a confirmed opt-in process). The registration information 420 may include data displayed on a web page 400 of the affiliate website 139 informing the customer that a message or other information may be sent to the customer using the registered customer's identifying information 410. The registration information 420 may also include an e-mail message 450 sent to the customer using the registered customer's identifying information 410. The e-mail message may include a registration hypertext link 422 that, upon selection by the customer, may cause a confirmation web page 465 (FIG. 4D) to be displayed within the customer's web browser 140 to complete the confirmed opt-in.

After the customer completes the confirmed opt-in process of block 504, the method 500 may associate the customer's identifying information 410 with the coupon 138B (FIG. 2B) at block 506. The association illustrated by block 506 may include adding the received identifying information 410 to a data structure 150 within the data warehouse 120 and associating that data structure 150 with the coupon object 138B. Association between the customer identifying information 410 and the coupon object 138B may also include any action that defines a relationship between the data structure 150 and the coupon 138B which allows an instance of either the data structure 150 or the coupon 138B to cause the other to perform an action (e.g., sending the coupon object 138B to a customer's e-mail address, as described below) on its behalf. Associating the identifying information 410 with the coupon 138B may also include adding or modifying a variable in the coupon object 138B that identifies the data structure 150, or adding or modifying a variable in the data structure 150 that identifies the coupon 138B.

At block 508, the coupon 138B may be sent to the customer. In some embodiments, a coupon e-mail message 475 (FIG. 4E) is sent to an e-mail address of the customer, as registered at block 504. The e-mail message may be sent after a threshold has been reached, for example, the threshold 214 (FIG. 2B). The threshold may include a period of time after which the method 500 sends the e-mail 475 to all customers that are registered with the coupon 138B and included within the data structure 150 after the opt-in process of block 504. The e-mail message 475 may include any other objects that are associated with the coupon 138A including the discount code 210, as well as a hypertext link object 138C including a hypertext link 220.

Returning to FIG. 3, the customer may receive the coupon e-mail message 475 at block 308. As described above, the coupon e-mail message 475 may include the discount code 201 and hypertext link 220. The customer may select the hypertext link 220 at block 310 to begin an affiliate referral process (as further described below), or may enter a URL into a web browser address area of the browser 140 to redirect the web browser 140 to a web page of the retailer's website 142 at block 312.

With reference to FIG. 6, if the user selects the hypertext link 220, the customer may launch an affiliate referral process 600 (FIG. 6) to ensure the affiliate and affiliate network receives a commission from any resulting sale. Upon selection of the hypertext link 220, an embedded URL 222 (FIG. 4E) of the hypertext link 220 may cause the customer's browser 140 to launch a web request to the affiliate network web server 121 at block 602. In some embodiments, the embedded URL may cause the customer's browser 140 to redirect to an affiliate network web server 121, and further redirect the customer's browser 140 to the retailer's web server 122 to access and open a retailer web page 700 (FIG. 7) on the retailer web site 142 in a new instance of the customer's web browser 140. Information within the embedded URL 224 of the hypertext link 220 may identify the affiliate to the affiliate network web server 121. For example, the embedded URL 222 may include an identifying code 224 or other information indicating to the affiliate network 110 that the coupon hosting system (affiliate) 116 was the source of the referral to the retailer 112.

Also at block 602, the controller or processor 121 B of the affiliate network web server 121 may receive, through the Internet 108, an instruction including the identifying code 224 as input for a function to be executed by the controller or processor 121 B. Using the identifying code 224, the processor or controller of the affiliate network web server 121 may then execute one or more instructions stored in the memory 121A (or elsewhere) to set an affiliate network's cookie 144 on the customer's computer at block 604. As described above, the value of the affiliate network's cookie 144 informs the retailer of both the affiliate network 110 and the affiliate 116. Optionally or additionally at block 604, selecting the hypertext link 220 may cause a function to be called to set a retailer's cookie 145 on the customer's web-enabled device 106 at block 604. As with the affiliate network's cookie, the retailer's cookie 145 may inform the retailer of both the affiliate network 110 and the affiliate 116.

At block 606, upon accessing a page of the retailer's website 700 (FIG. 7A), the retailer's web server processor 122B may execute one or more instructions stored in the web server memory 122A to read a retailer's cookie 145 on the customer's web-enabled device to determine if the cookie has been set. In some embodiments, the instructions may read one or both of the affiliate network's cookie 144 and the retailer's cookie 145. For example, the retailer web server 122 may send one or more commands to the customer's web-enabled device 106 to read the affiliate network's cookie 144 set by block 604. Additionally or alternatively, the retailer web server 122 may send one or more commands to the customer's web-enabled device 106 to read the retailer's cookie 145. If the retailer web server 122 discovers the set affiliate network's cookie 144, then the retailer web server 122 associates an indication of the affiliate network 110 with a record of any sales transaction that results from the referral to the retailer 112. The affiliate network 110 is then able to credit the coupon hosting system 116 (affiliate) with the sale. If the retailer web server 122 discovers the set retailer's cookie 145, then the retailer web server 122 associates an indication of the coupon hosting system 116 (affiliate) with a record of any sales transaction that results from the referral to the retailer 112. The coupon hosting system 116 (affiliate) is then credited with the sale. The indication of the affiliate network and affiliate's association with the transaction record may be stored within the memory 122A or any other memory as described herein. From the stored indication and transaction record, the affiliate network 110 and the coupon hosting system 116 may receive a sales commission according to terms of any agreement between the coupon hosting system (affiliate) 116, affiliate network 110, and retailer 112. If, however, the cookie 144,145 has not been set, then the retailer's web server 122 cannot determine which affiliate 116 or affiliate network 110 facilitated the transaction and no credit is awarded at block 608.

Once the customer completes the sales transaction, the retailer web server 122 logs the sale back to the affiliate network web server 121 at block 610. Additionally, the affiliate network server 121 may report the completed sale back to the coupon hosting system (affiliate) 116. Once the transaction has been reported to the coupon hosting system 116, the affiliate network 110 and the coupon hosting system (affiliate) 116 may earn a percentage commission on the completed sale.

Returning to FIG. 3, the customer shops at the retailer's website 700 at block 314 and, as part of the checkout process web page 725 (FIG. 7B), enters the coupon code 210 into a field 730 during the checkout process at block 314. In some embodiments, the customer manually enters the coupon code 210 into the field during the checkout process, while in other embodiments, the code is placed on the clipboard of the customer's web-enabled device to be pasted into the field by the customer during checkout. If the customer enters the code 210 correctly, a function of the retailer's web site may access a discount 212 of the coupon object 138B as identified by the code 210 and, if the threshold 214 or other conditions are met, then a discount 732 may be applied to the sales transaction.

At block 316, the method 300 may delete the customer's identifying information 410 associated with the coupon used in the online sale described above. In some embodiments, the method 300 may delete individual e-mail addresses of the customer's identifying information 410, or may merely delete the data structure 150 associated with the coupon object 138B once a threshold 214 has been reached or other limit that would indicate that the coupon code 210 of the coupon object 138B could not be used in any future online sales transaction. For example, the customer's identifying information 410 may be deleted upon expiration of a time period, after a number of uses, or based on some other factor that may be customized by the retailer or affiliate.

As described above, an affiliate website may encourage a high level of customer participation and ensure that the affiliate and affiliate network receive a commission from sales using an online coupon, without requiring a customer to register for and purchase the coupon. A customer may provide identifying information to an affiliate before the customer receives a certain coupon, and the affiliate may control the number of such available coupons while ensuring commission credit for any resulting sale.

This detailed description is to be construed as exemplary only and does not describe every possible embodiment, as describing every possible embodiment would be impractical, if not impossible. One could implement numerous alternate embodiments, using either current technology or technology developed after the filing date of this provisional patent application.

We claim:

1. An affiliate marketing system configured to provide a discount in a sales transaction to a customer via an online interface, the system comprising:
a program memory;
a processor; and
an online interface displaying a coupon hosting system object on a web-enabled computing device, the coupon hosting system object including a plurality of instructions stored in the program memory and executed by the processor, the coupon hosting system object including:
a coupon object including a discount code and a discount; and
a clickable object including instructions to:
register information identifying a customer,
distribute the discount code to the customer using the registered information identifying the customer, and
track a completed sales transaction, wherein the completed sales transaction uses the coupon object;
wherein the discount includes one or more conditions that, when met, result in a reduction of a retailer's normal price for the sales transaction.

2. The affiliate marketing system of claim 1, wherein the clickable object includes further instructions to delete the information identifying the customer after the discount code is distributed to the customer.

3. The affiliate marketing system of claim 1, wherein the coupon object further includes a threshold, the threshold indicating a limitation on the effectiveness of the discount, the limitation including an expiration date, a customer limit, and a period of effectiveness.

4. The affiliate marketing system of claim 1, wherein the coupon hosting system object further includes a link object, the link object including instructions executed by the processor to ensure an affiliate and an affiliate network receive commission credit for the sales transaction.

5. The affiliate marketing system of claim 1, wherein the clickable object includes further instructions to associate a customer's registered information with the coupon object.

6. The affiliate marketing system of claim 1, wherein the information identifying the customer includes an e-mail address and the clickable object includes further instructions to generate an e-mail message to the customer using the e-mail address, the e-mail message including the discount code.

7. The affiliate marketing system of claim 1, wherein the clickable object includes further instructions to launch a web request to an affiliate network server, the web request including an identifying code corresponding to the coupon hosting system, and to cause a cookie to be set on a web-enabled computing device, the cookie including the identifying code.

8. A method for providing a discount in a sales transaction using an online interface to a coupon hosting system via a browser of a web-enabled computing device, the method comprising:
receiving information identifying a customer via the online interface;
associating the information identifying the customer with the discount;
sending the discount to the customer using the information identifying the customer; and
causing the web-enabled computing device to redirect the browser to a web page of a retailer associated with the discount.

9. The method of claim 8, further comprising deleting the information identifying the customer after the discount code is sent to the customer.

10. The method of claim 8, wherein the discount includes one or more conditions that, when met, result in a reduction in a retailer's normal price for the sales transaction.

11. The method of claim 8, wherein the discount includes a threshold, the threshold indicating a limitation on the effectiveness of the discount, the limitation including an expiration time and a number of customers limit.

12. The method of claim 8, further comprising associating the information identifying the customer with the discount.

13. The method of claim 8, wherein causing the web-enabled computing device to redirect the browser to the web page of the retailer associated with the discount includes sending a web request to an affiliate network server, the web request including an identifying code corresponding to the coupon hosting system, and causing a cookie to be set on the web-enabled computing device, the cookie including the identifying code.

14. A computer-readable storage medium comprising computer-executable instructions executed by a processor of a web-enabled computing device, the instructions to provide a discount to a sales transaction using an online interface and a web-enabled computing device, the instructions to:
receive information identifying a customer via the online interface of the web-enabled computing device;
associate the information identifying the customer with the discount; and
send the discount to the customer using the information identifying the customer.

15. The computer-readable storage medium of claim 14, comprising further instructions to cause the web-enabled computing device to redirect a browser to a web page of a retailer associated with the discount.

16. The computer-readable storage medium of claim 15, wherein instructions to cause the web-enabled computing device to redirect the browser to the web page of the retailer associated with the discount includes instructions to send a web request to an affiliate network server, the web request including an identifying code corresponding to the coupon hosting system and causing a cookie to be set on the web-enabled computing device, the cookie including the identifying code.

17. The computer-readable storage medium of claim 14, comprising further instructions to delete the information identifying the customer after the discount code is sent to the customer.

18. The computer-readable storage medium of claim 14, wherein the discount includes one or more conditions that, when met, result in a reduction of a retailer's normal price for the sales transaction.

19. The computer-readable storage medium of claim 14, comprising further instructions to associate the information identifying the customer with the discount, wherein the information identifying the customer includes an e-mail address.

20. The computer-readable storage medium of claim 14, comprising further instructions to generate an e-mail message to the customer using the information identifying the customer, the e-mail message including the discount code.
